(19) United States
(12) Patent Application Publication
(10) Pub. No.: US 2011/0284181 A1
(43) Pub. Date: Nov. 24, 2011

(54) METHOD FOR HEATING AND/OR AIR-CONDITIONING IN A VEHICLE

(75) Inventor: Wissam Rached, Chaponost (FR)

(73) Assignee: ARKEMA FRANCE, Colombes (FR)

(21) Appl. No.: 13/146,721

(22) PCT Filed: Feb. 8, 2010
(86) PCT No.: PCT/FR10/50195

§ 371 Date: Jul. 28, 2011

(30) Foreign Application Priority Data
Feb. 13, 2009 (FR) 0950941

(51) Int. Cl. F01P 9/00; C09K 5/04

(52) U.S. Cl. 165/51; 252/67

(57) ABSTRACT

The present invention relates to a composition 2,3,3,3-tetrafluoropropene, 1,1,1,2-tetrafluoroethane and at least one compound selected from propane, propylene and ethylene, which can be used for refrigeration, air-conditioning and heating. The invention also relates to a method for heating and/or air-conditioning the passenger compartment of an automobile using a reversible cooling loop in which a refrigerant fluid including said composition flows. The method is particularly suitable for when the outdoor temperature is lower than −20° C. The method is also suitable for use in hybrid vehicles adapted for alternately operating by means of a thermal engine and an electric motor, as well as for electric vehicles.

The present invention relates to a composition comprising 2,3,3,3-tetrafluoropropene, suitable for use for cooling, airconditioning and heating, in particular in heat pumps.

In motor vehicles, the internal combustion engine comprises a coolant flow circuit that is used to cool the engine and also to heat the passenger compartment. For this purpose, the circuit comprises in particular a pump and a space heater conveying an air flow which recovers the heat stored by the coolant in order to heat the passenger compartment.

Furthermore, an airconditioning system for cooling the passenger compartment of a motor vehicle comprises an evaporator, a compressor, a condenser, a thermostatic expansion valve and a fluid capable of chancing state (liquid/gas) commonly called a coolant. The compressor which is directly driven by the vehicle engine by means of a belt and pulley, compresses the coolant, discharges it under high pressure and at high temperature to the condenser. Thanks to forced ventilation, the condenser causes the condensation of the gas entering in the gaseous state at high pressure and high temperature. The condenser liquefies the gas by lowering the temperature of the air passing through it. The evaporator is a heat exchanger which extracts the heat from the air that is blown into the passenger compartment. The thermostatic expansion valve serves to control the flow rate of the gas entering the loop by altering the flow area depending on the temperature and pressure in the evaporator. Thus, the hot air from the exterior is cooled as it passes through the evaporator.

The airconditioning system in electric cars is hermetically sealed: the compressor is electric and the architecture of the system can be confined with an intermediate heat transfer circuit (glycol type).

The commonly used coolant in automobile airconditioning is 1,1,1,2-tetrafluoroethane (HFC-134a).

Document WO 2008/107623 describes a motor vehicle energy management system comprising a reversible cooling loop with coolant flow, mobile means for reversing the operating cycle of the cooling loop between a cooling mode position and a heat pump mode position, at least one first source suitable for recovering the energy from the coolant, and at least one second source suitable for evaporating the coolant following the expansion of said fluid from the liquid state to the two-phase state, the reversing means being suitable for allowing the flow of coolant from the first recovery source to at least one evaporation source, when they are in a position identical to that corresponding to the heat pump mode.

However, with HF-134a as coolant in the system as described in document WO 2008/107623, when the exterior temperature is around −15° C., a negative pressure begins to form in the evaporator even before the compressor is started. This negative pressure, which causes air to infiltrate into the system, promotes the corrosion and deterioration of the components such as the compressor, heat exchanger and thermostatic expansion valve.

It is the object of the present invention to provide a heat transfer fluid and its uses, in particular as coolant in a cooling loop for preventing the air from entering the evaporator of the cooling loop upon the startup of the compressor and/or for improving the efficiency of the cooling loop.

One object of the invention is therefore a composition comprising 5 to 80% by weight of 2,3,3,3-tetrafluoropropene, 5 to 25% by weight of 1,1,1,2-tetrafluoroethane and 2 to 50% by weight of at least one compound of group C selected from propane, propylene and ethylene.

Preferably, the composition of the present invention comprises 40 to 75%, preferably 50 to 75% and most preferably 5 to 75% by weight of 2,3,3,3-tetrafluoropropene, 5 to 30% by weight of 1,1,1,2-tetrafluoroethane and 15 to 40% by weight of at least one compound of group C selected from propane, propylene and ethylene.

Advantageously, the composition of the invention comprises 60 to 70% by weight, of 2,3,3,3-tetrafluoropropylene, 5 to 15% by weight of 1,1,1,2-tetrafluoroethane and 25 to 35% by weight of at least one compound of group C selected from propane, propylene and ethylene.

The preferred compound of group C is propane.

The composition of the present invention is particularly suitable as a heat transfer fluid for cooling, airconditioninq and heating.

The composition of the present invention can be used for cooling to replace currently available coolants such as R-22 (chlorodifluoromethane), R-404A (mixture consisting 4% by weight of 1,1,1,2-tetrafluoroethane, 52% by weight of trifluoroethane and 44% by weight of pentafluoroethane) and R-407C (mixture consisting of 52% by weight of 1,1,1,2-tetrafluoroethane, 23% by weight of difluoromethane and 25% by weight of pentafluoroethane). R-407C is used as a coolant in shopping centers (supermarkets), in refrigerated transport, in heat pumps and reversible heat pumps for cooling and heating. However, R-407C has a GWP of 1800.

The contribution of a fluid to the greenhouse effect is quantified by a criterion, the GWP (Global. Warning Potential), which summarizes the heating power by taking a reference value of 1 for carbon dioxide.

The composition of the invention has a GWP lower than 450.

The composition of the present invention can also be used for airconditioning, preferably in automobile airconditioning.

The composition of the present invention may further be used for heating, in particular in heat pumps and preferably for heating a motor vehicle passenger compartment.

A further object of the present invention is a method for heating and/or airconditioning a passenger compartment of a motor vehicle using a reversible cooling loop, in which a cooling fluid flows, comprising a first heat exchanger, a thermostatic expansion valve, a second heat exchanger, a compressor and means for reversing the flow direction of the coolant, characterized in that the coolant comprises the composition as defined above.

The means for reversing the coolant, flow direction in the cooling loop in order to reverse the operating cycle thereof may consist of a four-way valve. The coolant may also comprise stabilizers of 2,3,3,3-tetrafluoropropene. As examples of stabilizers, mention can be made in particular of nitromethane, ascorbic acid, terephthalic acid, azoles such as tolutriazole or benzotriazole, phenolic compounds such as tocopherol, hydroquinone, t-butyl hydroquinone, 2,6-di-tert-butyl-4-methylphenol, epoxies (alkyl optionally fluorinated or perfluorinated or alkenyl or aromatic) such as n-butyl glycidyl ether, hexanediol diglycidyl ether, allyl glycidyl ether, butylphenylglycidyl ether, phosphites, phosphates, phosphonates, thiols and lactones.

Depending on the operating mode of the loop, cooling mode or heat pump mode, a first heat exchanger may act as an evaporator or energy regenerator. The same applies to the second heat exchanger. In cooling mode, the second heat exchanger serves to cool the air flow intended to be sent into the motor vehicle passenger compartment. In heat pump mode, the second heat exchanger serves to heat the air flow intended for the motor vehicle passenger compartment.

The first and second heat exchangers are of the air/coolant type. Liquid/coolant heat exchangers can also be used be used, so that the liquid plays the role of an intermediate fluid and transfers energy to the air.

In the method of the present invention, the cooling loop may be thermally coupled, via the heat exchangers, with the engine cooling circuit. Thus, the loop may comprise at least one heat exchanger traversed both by the coolant and by a heat transfer fluid, in particular the air or the water of the internal combustion engine cooling circuit.

According to an alternative of the method, the first heat exchanger is traversed both by the coolant, and by the exhaust gas from the motor vehicle internal combustion engine; said gases may thermally communicate with a heat transfer fluid circuit.

The cooling loop in the method of the present invention may comprise, on a bypass, at least one heat exchanger communicating thermally with an air flow, intended to be sent into the motor vehicle internal combustion engine, or with exhaust gases from the motor vehicle internal combustion engine.

The method of the present invention is particularly suitable when the exterior temperature is lower than 20° C., preferably lower than −30° C.

The cooling loop in the method of the present invention, in heat pump mode, can heat the air from the exterior having a very low temperature, and then in inject it into the passenger compartment to renew the air therein. The heat exchange between the cold exterior air and the coolant is provided by the condenser of the loop, either directly or via an intermediate heat exchanger comprising a heat transfer fluid. Said heat exchange with the condenser allows the condensation of the coolant via the condenser and also the subcooling of said coolant to temperatures close to the exterior temperature.

The method of the present invention is also suitable for hybrid motor vehicles which are designed to operate alternately with internal combustion engine and electric engine. It serves to optimally manage the energy inputs according to the climatic conditions (hot or cold) both for the passenger compartment and for the battery and, in particular, to supply heat or cold to the battery via a heat transfer fluid circuit.

The reversible cooling loop, in which the coolant comprising the abovementioned composition flows, installed in motor vehicles, is particularly suitable for recovering energy from the internal combustion engine and/or from the electric battery that is useful for heating the passenger compartment and the internal combustion engine during a cold starting phase. Said reversible cooling loop, when it comprises a pump, can operate in Rankine mode (that is to say, the compressor operates like a turbine) to utilize the heat energy generated by the internal combustion engine and then conveyed by the coolant, after heat transfer.

A further subject of the invention is a device comprising the cooling loop as described above.

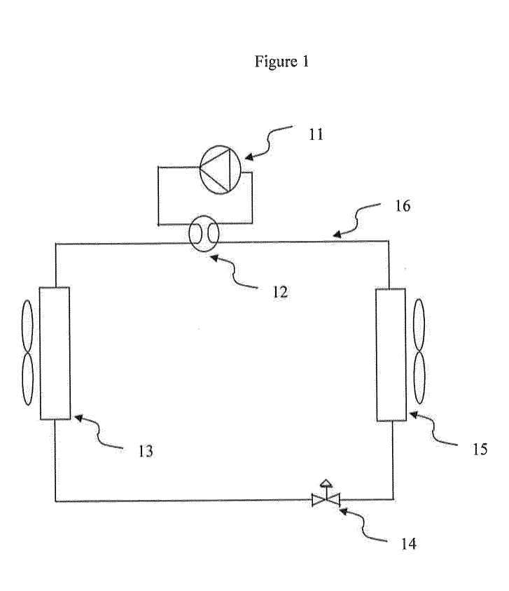

According to a first embodiment of the invention, shown schematically in FIG. 1, the cooling loop (16) comprises a first heat exchanger (13), a thermostatic expansion valve (14), a second heat exchanger (15), a compressor (11) and a four-way valve (12). The first and second heat exchangers are of the air/coolant type. The first neat exchanger (13) is traversed by the coolant from the loop (16) and by the air flow conveyed by a fan. Part or all of said air flow also passes through a heat exchanger of the engine cooling circuit (not shown in the figure). Similarly, the second heat exchanger (15) is traversed by an air flow conveyed by a fan. Part or all of said air flow also passes through another heat exchanger of the engine cooling circuit (not shown in the figure). The air flow direction depends on the operating mode of the loop (15) and the needs of the internal combustion engine. Thus, when the internal combustion engine is in steady state conditions and the loop (16) is in heat pump mode, the air can be heated by the heat exchanger of the internal combustion engine cooling circuit and then blown on the heat exchanger (13) to accelerate the evaporation of the fluid from the loop (16) and thereby improve the performance of said loop.

The heat exchangers of the cooling circuit can be activated by means of valves according to the needs of the internal combustion engine (heating the air entering the engine or utilizing the energy generated by said engine).

In cooling mode, the coolant set in motion by the compressor (11) traverses, via the valve (12), the heat exchanger (13) acting as a condenser (that is to say, releasing heat to the exterior), followed by the thermostatic expansion valve (14), and then the heat exchanger (15) acting as the evaporator, thereby allowing the cooling of the air flow intended to be sent into the passenger compartment of the motor vehicle.

In heat pump mode, the coolant flow direction is reversed via the valve (12). The heat exchanger (15) plays the role of a condenser while the heat exchanger (13) plays the role of an evaporator. The heat exchanger (15) then serves to heat the air flow intended for the passenger compartment of the motor vehicle.

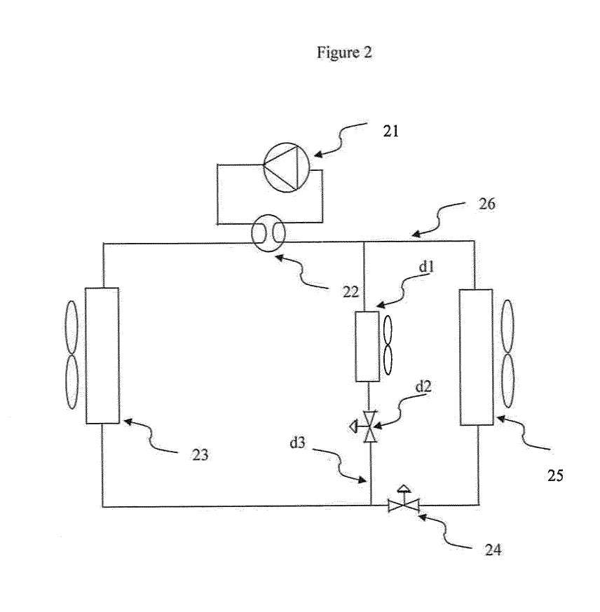

According to a second embodiment of the invention, shown schematically in FIG. 2, the cooling loop (26) comprises a first heat exchanger (23), a thermostatic expansion valve (24), a second heat exchanger (25), and compressor (21), a four-way valve (22) and a bypass branch (d3) mounted on the one hand at the outlet of the heat exchanger (23) and on the other hand at the outlet of the heat exchanger (25), considering the fluid flow in cooling mode. Said branch comprises a heat exchanger (d1) traversed by an air flow or an exhaust gas flow intended to be sent into the internal combustion engine and a thermostatic expansion valve (d2). The first and second heat exchangers (23 and 25) are of the air/coolant type. The first heat exchanger (23) is traversed by the coolant from the loop (26) and by the air flow conveyed by a fan. Part or all of said air flow also passes through a heat exchanger of the engine cooling circuit (not shown in the figure). Similarly, the second heat exchanger (25) is traversed by an air flow conveyed by a fan. Part or all of said air flow also passes through another heat exchanger of the engine cooling circuit (not shown in the figure). The air flow direction depends on the operating mode of the loop (26) and on the needs of the internal combustion engine. For example, when the internal, combustion engine, is in steady state conditions and the loop (26) is in heat pump mode, the air can be heated by the heat exchanger of the internal combustion engine cooling circuit and then blown on the heat exchanger to accelerate the evaporation of the fluid of the loop (26) and improve the performance of said loop.

The heat exchangers of the cooling circuit can be activated by means of valves according to the needs of the internal, combustion engine (heating of the air entering the engine or utilization of the energy generated by said engine).

The heat exchanger (d1) can also be activated according to the energy needs, whether in cooling mode or in heat pump mode. Shutoff valves can be installed on the branch (d3) to activate or deactivate said branch.

The heat exchanger (d1) is traversed by an air flow conveyed by a fan. Said air flow can pass through another heat exchanger of the engine cooling circuit and also other heat exchangers placed on the exhaust gas circuit, on the engine air intake or on the battery in hybrid cars.

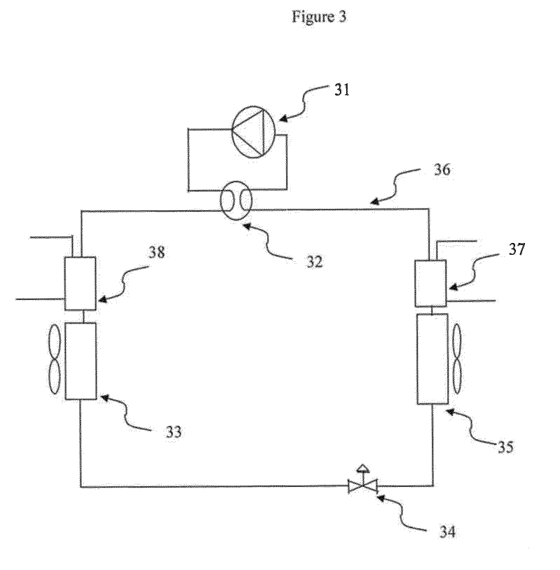

According to a third embodiment of the invention, shown schematically in FIG. 3, the cooling loop (36) comprises a first heat exchanger (33), a thermostatic expansion valve (34), a second heat exchanger (35), a compressor (31) and a four-way valve (32). The first and second heat exchangers (33 and 35) are of the air/coolant type. The operation of the heat exchangers (33 and 35) is identical to the first embodiment shown in FIG. 1. Two fluid/liquid heat exchangers (38 and 37) are installed both on the circuit of the cooling loop (36) and on the cooling circuit of the internal combustion engine or on a secondary glycol water circuit. The installation of the fluid/liquid heat exchangers without passing through a gaseous intermediate fluid (air) serves to improve the heat exchanges in comparison with air/fluid heat exchangers.

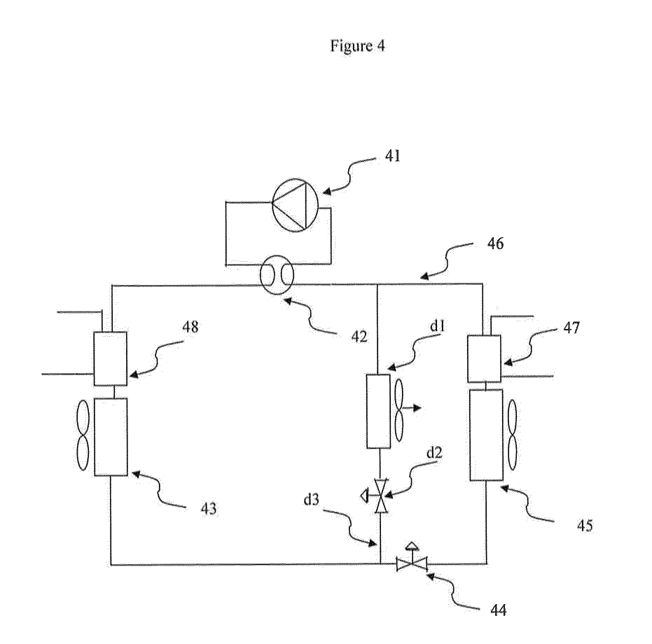

According to a fourth embodiment of the invention, shown schematically in FIG. 4, the cooling loop (46) comprises a first series of heat exchangers (43 and 48), a thermostatic expansion valve (44), a second series of heat exchangers (45 and 47), a compressor (41) and a four-way valve (42). A bypass branch (d1) is mounted on the one hand at the outlet of the heat exchanger (43), and on the other hand at the outlet of the heat exchanger (47) considering the fluid flow in cooling mode. Said branch comprises a heat exchanger (d1) traversed by an air flow or an exhaust gas flow intended to be sent into the internal combustion engine and a thermostatic expansion valve (d2). The operation of this branch is identical to the second embodiment shown in FIG. 2.

The heat exchangers (43 and 45) are of the air/coolant type and the heat exchangers (48 and 47) are of the liquid/coolant type. The operation of these exchangers is identical to the third embodiment shown in FIG. 3.

The method of the present invention is also suitable for electric motor vehicles which are designed to operate with a battery. It serves to optimally manage the energy inputs according to the climatic conditions (hot or cold), both for the passenger compartment and for the battery and, in particular, to provide heat or cold to the battery through a heat transfer fluid circuit.

The method of the present invention is further suitable for vehicles operating with hydrogen.

### EXPERIMENTAL PART

Reversible heat pump in heating mode:

Simulations of the performance of the coolant in the heat pump operating conditions in vehicles and by setting the condenser temperature at 40° C., are given below.

Condensation temperature: +40° C. (T cond)
Compressor inlet temperature: −10° C. (Te comp)
Evaporator outlet temperature: −20° C. (Evap outlet temp)
Thermostatic expansion valve inlet temperature: −10° C.
Evac P: is the pressure in the evaporator
Cond P: is the pressure in the condenser
Ratio: the compression ratio is the ratio of the high pressure to the low pressure.
Slide: this is the variation in temperature along the evaporator
COP: coefficient of performance, defined, for a heat pump, as the useful heating power supplied by the system over the power supplied or consumed by the system.
CAP: volumetric capacity, that is, the heat capacity per unit volume (kJ/m³)
% CAP or COP is a ratio of the value of the CAP or COP of the composition of the present invention compared to those of R-407C.

Isentropic efficiency of the compressor: the ratio between the actual energy transmitted to the fluid and the isentropic energy.

The isentropic efficiency of the compressor is considered to be equal to 0.7.

| | | | | | | | | Thermostatic |
|---|---|---|---|---|---|---|---|---|
| | | | | | | | | expansion |
| | | | Evaporator | Evaporator | Compressor | Condenser | Condensation | valve |
| | | | inlet temp | outlet temp | inlet temp | inlet temp | temperature | inlet temp |
| | | | (° C.) | (° C.) | (° C.) | (° C.) | (° C.) | (° C.) |
| | | | R407C | | | | | |
| A | B | C | −26.2 | −20 | −10 | 96.7 | 40 | −10 |
| 50 | 10 | 40 | 20.6 | −20 | −10 | 70.6 | 40 | −10 |
| 55 | 10 | 35 | 21.2 | −20 | −10 | 70.6 | 40 | −10 |
| 60 | 10 | 30 | 22.1 | −20 | −10 | 70.8 | 40 | −10 |
| 62 | 10 | 28 | 22.4 | −20 | −10 | 70.9 | 40 | −10 |

| | | | Evap P | Cond P | Ratio | | density | CAP | | | |
|---|---|---|---|---|---|---|---|---|---|---|---|
| | | | (kPa) | (kPa) | (p/p) | slide | (kg/m3) | (KJ/m3) | COP | % CAP | % COP |
| | | | R407C | | | | | | | | |
| A | B | C | 214 | 1733 | 8.1 | 6 | 8.84 | 2650 | 3.8 | 100 | 100 |
| 50 | 10 | 40 | 266 | 1543 | 5.8 | 1 | 8.97 | 2918 | 4.2 | 110 | 110 |
| 55 | 10 | 35 | 257 | 1530 | 2.9 | 1 | 9.12 | 2841 | 4.2 | 107 | 110 |
| 60 | 10 | 30 | 246 | 1510 | 6.1 | 2 | 9.15 | 2734 | 4.2 | 103 | 108 |
| 62 | 10 | 28 | 241 | 1499 | 6.2 | 2 | 9.15 | 2685 | 4.1 | 101 | 108 |

A: HFO-1234yf in % by weight
B: HFC-134a % by weight
C: Propane % by weight

Reversible heat pump in cooling mode:

Simulations of performance of the coolant in the operating conditions of air cooling in the vehicles and by setting the temperature in the evaporator at 5° C. are given below.

Condensation temperature: +40° C. (T cond)
Compressor inlet temperature: 15° C. (Te comp)
Evaporator outlet temperature: 5° C. (Evap outlet temp)
Thermostatic expansion valve inlet temperature: 35° C.
Evap P: is the pressure in the evaporator
Cond P: is the pressure in the condenser
Slide: the variation in temperature along the evaporator
Ratio: the compression ratio is the ratio of the high pressure to the low pressure.
COP: coefficient of performance, defined, for a heat pump, as the useful heating power supplied by the system over the power supplied or consumed by the system.
CAP: volumetric, capacity, that is to say, the heat capacity per unit volume (kJ/m³)
% CAP or COP is a ratio of the value of the CAP or COP of the composition of the present invention compared to those of R-407C.

Isentropic efficiency of the compressor: the ratio between the actual energy transmitted to the fluid and the isentropic energy.

The isentropic efficiency of the compressor is considered to be equal to 0.7.

| | | | | | | | | Thermostatic |
|---|---|---|---|---|---|---|---|---|
| | | | | | | | | expansion |
| | | | Evaporator | Evaporator | Compressor | Condenser | Condensation | valve |
| | | | inlet temp | outlet temp | inlet temp | inlet temp | temperature | inlet temp |
| | | | (° C.) | (° C.) | (° C.) | (° C.) | (° C.) | (° C.) |
| | | | R407C | | | | | |
| A | B | C | 0.2 | 5 | 15 | 77.7 | 40 | 35 |
| 50 | 10 | 40 | 4.6 | 5 | 15 | 60.2 | 40 | 35 |
| 55 | 10 | 35 | 4.1 | 5 | 15 | 60.3 | 40 | 35 |
| 60 | 10 | 30 | 3.5 | 5 | 15 | 60.6 | 40 | 35 |

| | | | Evap P | Cond P | Ratio | | density | CAP | | | |
|---|---|---|---|---|---|---|---|---|---|---|---|
| | | | (kPa) | (kPa) | (p/p) | slide | (kg/m3) | (KJ/m3) | COP | % CAP | % COP |
| | | | R407C | | | | | | | | |
| A | B | C | 542 | 1733 | 3.2 | 4.8 | 21.4 | 3638 | 3.9 | 100 | 100 |
| 50 | 10 | 40 | 609 | 1543 | 2.5 | 0.4 | 19.9 | 3613 | 4.5 | 99 | 114 |
| 55 | 10 | 35 | 595 | 1530 | 2.6 | 0.9 | 20.4 | 3531 | 4.4 | 97 | 112 |
| 60 | 10 | 30 | 575 | 1510 | 2.6 | 1.5 | 20.7 | 3419 | 4.3 | 94 | 110 |

A: HFO-1234yf in % by weight
B: HFC-134a % by weight
C: Propane % by weight

1. A composition comprising 5 to 80% by weight of 2,3,3,3-tetrafluoropropene, 5 to 25% by weight of 1,1,1,2-tetrafluoroethane and 2 to 50% by weight of at least one compound of group C selected from the group consisting of from propane, propylene and ethylene.

2. The composition as claimed in claim 1, characterized in that it comprises 55 to 75% by weight of 2,3,3,3-tetrafluoropropylene, 5 to 30% by weight of 1,1,1,2-tetrafluoroethane and 15 to 40% by weight of at least one compound of group C selected from the group consisting of propane, propylene and ethylene.

3. The composition as claimed in claim 1, characterized in that it comprises 60 to 70% by weight of 2,3,3,3-tetrafluoropropylene, 5 to 15% by weight of 1,1,1,2-tetrafluoroethane and 25 to 35% by weight of at least one compound of group C selected from the group consisting of propane, propylene and ethylene.

4. A method for heating and/or airconditioning a passenger compartment of a motor vehicle using a reversible cooling loop, comprising flowing a cooling fluid through: a first heat exchanger, a thermostatic expansion valve, a second heat exchanger, a compressor and means for reversing the flow direction of the coolant, characterized in that the coolant comprises 5 to 80% by weight of 2,3,3,3-tetrafluoropropene, 5 to 25% by weight of 1,1,1,2-tetrafluoroethane and 2 to 50% by weight of at least one compound of group C selected from the group consisting of from propane, propylene and ethylene.

5. The method as claimed in claim 4, characterized in that the first and second heat exchangers are of the air/coolant type.

6. The method as claimed in claim 4, characterized in that the first and second heat exchangers are of the liquid/coolant type and further comprise a secondary circuit to transfer energy to air sent to the passenger compartment of the motor vehicle.

7. The method as claimed in claim 4, characterized in that the cooling loop is thermally coupled with a cooling circuit of an internal combustion engine of the motor vehicle.

8. The method as claimed in claim 4, characterized in that the first heat exchanger is traversed both by the coolant and by exhaust gases from an internal combustion engine of the motor vehicle.

9. The method as claimed in claim 4, characterized in that the cooling loop further comprises a bypass having at least one heat exchanger thermally communicating with an air flow admitted into the internal combustion engine of the motor vehicle, or with exhaust gases from the internal combustion engine of the motor vehicle.

10. The method as claimed in claim 4, characterized in that the cooling loop is installed in the motor vehicle for recovering energy from an internal combustion engine and/or from an electric battery of said motor vehicle.

11-13. (canceled)
